(19) United States
(12) Patent Application Publication
(10) Pub. No.: US 2025/0060475 A1
(43) Pub. Date: Feb. 20, 2025

(54) METHOD AND APPARATUS FOR ARTIFICIAL INTELLIGENCE RECOGNITION OF GROUND PENETRATING RADAR IMAGES

(71) Applicant: JIANGSU SINOROAD TRANSPORTAION SCIENCE AND TECHNOLOGY CO., LTD., Nanjing, Jiangsu (CN)

(72) Inventors: Zhixiang ZHANG, Nanjing (CN); Guanglai JIN, Nanjing (CN); Yang YANG, Nanjing (CN); Wenlong CAI, Nanjing (CN); Guoshuai ZANG, Nanjing (CN)

(21) Appl. No.: 18/722,736

(22) PCT Filed: Jan. 14, 2022
(86) PCT No.: PCT/CN2022/071951

§ 371 Date: Jun. 21, 2024

(30) Foreign Application Priority Data
Dec. 29, 2021 (CN) 202111640229.8

(51) Int. Cl. G01S 13/89; G06V 10/82

(52) U.S. Cl. CPC G01S 13/89; G06V 10/82

(57) ABSTRACT

A method for artificial intelligence recognition of ground penetrating radar images first obtains a noise-free high-resolution simulated ground penetrating radar image through forward simulation; obtains the ground penetrating radar field test data and determines the manual features; establishes a ground penetrating radar graph library based on the simulated ground penetrating radar image and the ground penetrating radar test image; uses a multi-layer convolutional neural network to process the measured image data of the target to determine the autonomous learning features; and finally, determines the final type and final location information of the target disease based on the manual features, the autonomous learning features, and the ground penetrating radar graph library using the committee discrimination method. The accuracy and efficiency of recognition of internal diseases in pavement structures is improved by constructing a ground penetrating radar graph library that integrates manual features, autonomous learning features, and the committee discrimination method.

### TECHNICAL FIELD

The present application relates to the technical field of pavement ground penetrating radar image recognition, in particular to a method and apparatus for artificial intelligence recognition of ground penetrating radar images.

### BACKGROUND

Ground penetrating radar is an effective means of detecting underground targets developed in recent years. It uses antennas to transmit and receive high-frequency electromagnetic waves to detect the characteristics and distribution patterns of materials inside the medium, and is a non-destructive detection technology. Compared with other conventional underground detection methods, it has the advantages of fast detection speed, continuous detection process, high resolution, convenient and flexible operation, and low detection cost. It is increasingly widely used in the field of geotechnical investigation and surveying. At present, the analysis of ground penetrating radar data mainly relies on manual inspection for identification. The identification results largely rely on the experience of the inspectors. There are shortcomings such as strong subjectivity and long interpretation cycle, as well as false positive and false negative. Therefore, the development of efficient, automatic and accurate ground penetrating radar signal analysis algorithms is an urgent problem to be solved.

Traditional algorithms based on manual features and classifier recognition include TM model inversion of Maxwell's equations, S-transform, imaging algorithm based on compressed sensing, support vector machine, and disease recognition based on extension evaluation. The TM model inversion of Maxwell's equations can reduce the clutter generated by various types of inhomogeneous media and accurately describe the random inhomogeneous distribution of actual medium. The S-transform is an extended algorithm of short-time variable window Fourier transform and wavelet transform, which has the advantages of high frequency resolution in the high frequency range and high time resolution in the low frequency range. It can improve signal resolution, but its complexity is relatively high. The compressed sensing based imaging algorithm can use fewer random sampling signals to achieve signal reproduction of ground penetrating radar, but it cannot classify the diseases. Support Vector Machine (SVM) is a binary classification model algorithm based on supervised learning. The basic working principle of this algorithm is to find the optimal classification hyperplane that maximizes the edge distance between two types of samples under this hyperplane. The larger the edge distance, the wider the separation between the two types of samples, and the better the classification results. This algorithm requires manual extraction of disease features, and the recognition results are affected by the extracted features. The theoretical basis of the extension evaluation of road diseases is extension theory. That is, it takes matter-element as the basic unit, which can be used to extract the feature category and feature value of the diseases, based on which the classification of disease levels can be carried out. Based on the data collected by ground penetrating radar, the interlayer void level classification is carried out by using extension evaluation, and the node domain of each directional index, the classical domain under each void state and the weight coefficient are determined to obtain a higher void recognition rate and a lower false positive rate.

With the continuous development of machine learning, deep learning has made great achievements in the field of image recognition in recent years, among which the achievements of convolutional neural networks and their variants are the most remarkable. Deep learning based recognition techniques have been used to recognize internal diseases in pavement structures. However, currently, artificially designed features and classifiers, including artificial neural networks and support vector machines, still have many shortcomings. Specifically, the internal diseases of pavement structures are diverse in shape and size, and the representation ability of artificial features is limited. It is difficult to adapt to the complex and changing disease environment, and the recognition accuracy is difficult to meet the actual application requirements.

The existing automated recognition methods based on convolutional neural networks have the disadvantages that it is difficult to use a single feature to characterize the diseases with universality and versatility as the morphological characteristics of internal diseases of the same pavement structure vary.

### SUMMARY

The present application discloses a method and apparatus for artificial intelligence recognition of ground penetrating radar images, which solve the technical problems that the existing automated recognition methods based on convolutional neural networks have the disadvantages that it is difficult to use a single feature to characterize the diseases with universality and versatility as the morphological characteristics of internal diseases of the same pavement structure vary.

In a first aspect, the present application discloses a method for artificial intelligence recognition of ground penetrating radar images, comprising:
performing forward simulation on the existing diseases data of different types to obtain a simulated ground penetrating radar image that is noise free and of high resolution;
for any type of disease data, performing forward simulation on different center frequencies of the transmitting antenna of the ground penetrating radar to obtain a simulated center frequency of the transmitting antenna;
collecting data on different pavements using the simulated center frequency of the transmitting antenna to obtain ground penetrating radar field test data and determine manual features;
based on the ground penetrating radar field test data, selecting a typical disease image and carrying out coring verification to determine a ground penetrating radar test image;
establishing a ground penetrating radar graph library based on the simulated ground penetrating radar image and the ground penetrating radar test image;
obtaining the measured image data of targets collected by the ground penetrating radar, and determining the autonomous learning features through a multi-layer convolutional neural network;
determining an initial type and initial location information of a target disease based on the manual features, the autonomous learning features, and the ground penetrating radar graph library; and
identifying the initial type and the initial location information of the target disease using a committee discrimination method to determine the final type and final location information of the target disease.

Optionally, performing forward simulation on the existing diseases data of different types to obtain a simulated ground penetrating radar image comprises:
performing forward simulation on the existing diseases data of different types using GPRMAX based on finite-difference time-domain (FDTD) method to obtain the simulated ground penetrating radar image.

Optionally, the types of disease data include multiple gaps inside the pavement structure, poor interlayers, loose interlayers and loose structures.

Optionally, establishing a ground penetrating radar graph library based on the simulated ground penetrating radar image and the ground penetrating radar test image comprises:
reconstructing and expanding the simulated ground penetrating radar image and the ground penetrating radar test image using data augmentation technology and transfer learning technology to establish the ground penetrating radar graph library.

Optionally, the ground penetrating radar graph library includes images of non-diseases, images of multiple gaps, images of poor interlayers, images of loose interlayers and images of loose structures.

Optionally, obtaining the measured image data of targets collected by the ground penetrating radar, and determining the autonomous learning features through a multi-layer convolutional neural network comprises:
determining a feature layer and generating a candidate region box by subjecting the measured image data of the target to a pre-constructed region proposal network (RPN) structure based on multi-layer feature fusion in the multi-layer convolutional neural network; and
performing a non-negative maximum suppression operation on the candidate region box and summarizing it to determine the autonomous learning feature.

Optionally, determining an initial type and initial location information of a target disease based on the manual features, the autonomous learning features, and the ground penetrating radar graph library comprises:
determining the initial type and initial location information of the target disease by subjecting the manual features and the autonomous learning features to a pre-constructed image classification network structure based on manual features and fused multi-layer features, and based on the ground penetrating radar graph library.

Optionally, identifying the initial type and the initial location information of the target disease using a committee discrimination method to determine the final type and final location information of the target disease comprises:
establishing a committee comprising a plurality of discrimination methods; and
for any discrimination method, identifying the initial type and the initial location information of the target disease to determine the recognition result; and
judging whether the recognition results of the plurality of discrimination methods are consistent, if so, the final type and the final location information of the target disease are determined based on the recognition result; if not, the committee votes to determine the final type and the final location information of the target disease.

Optionally, the plurality of discrimination methods includes Softmax discrimination method, Triplet discrimination method and K-L discrimination method.

In a second aspect, the present application discloses an apparatus for artificial intelligence recognition of ground penetrating radar images for use in method for artificial intelligence recognition of ground penetrating radar images described according to the first aspect of the present application, comprising:
a simulated image acquisition module configured to perform forward simulation on the existing diseases data of different types to obtain a simulated ground penetrating radar image that is noise free and of high resolution;
a simulated frequency acquisition module configured to, for any type of disease data, perform forward simulation on different center frequencies of the transmitting antenna of the ground penetrating radar to obtain a simulated center frequency of the transmitting antenna;
a manual feature determination module configured to collect data on different pavements using the simulated center frequency of the transmitting antenna to obtain ground penetrating radar field test data and determine manual features;
a test image determination module configured to, based on the ground penetrating radar field test data, select a typical disease image and carry out coring verification to determine a ground penetrating radar test image;
a graph library construction module configured to establish a ground penetrating radar graph library based on the simulated ground penetrating radar image and the ground penetrating radar test image;
an autonomous learning feature determination module configured to obtain the measured image data of targets collected by the ground penetrating radar, and determine the autonomous learning features through a multi-layer convolutional neural network;
a target disease initial information determination module configured to determine an initial type and initial location information of a target disease based on the manual features, the autonomous learning features, and the ground penetrating radar graph library; and
a target disease final information determination module configured to identify the initial type and the initial location information of the target disease using a committee discrimination method to determine the final type and final location information of the target disease.

Optionally, the simulated image acquisition module comprises:
a GPRMAX unit configured to perform forward simulation on the existing diseases data of different types using GPRMAX based on finite-difference time-domain (FDTD) method to obtain the simulated ground penetrating radar image.

Optionally, the graph library construction module comprises:
a reconstruction and expansion unit configured to reconstruct and expand the simulated ground penetrating radar image and the ground penetrating radar test image using data augmentation technology and transfer learning technology to establish the ground penetrating radar graph library.

Optionally, the autonomous learning feature determination module comprises:
a candidate region box generation unit configured to determine a feature layer and generate a candidate region box by subjecting the measured image data of the target to a pre-constructed RPN network structure based on multi-layer feature fusion in the multi-layer convolutional neural network; and
an autonomous learning feature acquisition unit configured to perform a non-negative maximum suppression operation on the candidate region box and summarize it to determine the autonomous learning feature.

Optionally, the target disease initial information determination module comprises: a target disease initial information acquisition unit configured to determine the initial type and initial location information of the target disease by subjecting the manual features and the autonomous learning features to a pre-constructed image classification network structure based on manual features and fused multi-layer features, and based on the ground penetrating radar graph library.

Optionally, the target disease final information determination module comprises:
a committee establishment unit configured to establish a committee comprising a plurality of discrimination methods;
a recognition result determination unit configured to, for any discrimination method, identify the initial type and the initial location information of the target disease and determine the recognition result; and
a target disease final information acquisition unit configured to judge whether the recognition results of the plurality of discrimination methods are consistent, if so, the final type and the final location information of the target disease are determined based on the recognition result; if not, the committee votes to determine the final type and the final location information of the target disease.

The present application relates to the technical field of pavement ground penetrating radar image recognition, and discloses to a method and apparatus for artificial intelligence recognition of ground penetrating radar images. The method first obtains a noise-free high-resolution simulated ground penetrating radar image through forward simulation. Then, it obtains the ground penetrating radar field test data and determines the manual features. It establishes a ground penetrating radar library based on the simulated ground penetrating radar image and the ground penetrating radar test image. It uses a multi-layer convolutional neural network to process the measured image data of the target to determine the autonomous learning features. Finally, it determines the final type and final location information of the target disease based on the manual features, the autonomous learning features, and the ground penetrating radar graph library using the committee discrimination method. The present application can effectively improve the accuracy and efficiency of recognition of internal diseases in pavement structures by constructing a ground penetrating radar graph library that integrates manual features and autonomous learning features, in combination with the committee discrimination method.

### DESCRIPTION OF THE DRAWINGS

In order to more clearly explain the technical proposal of the present application, the accompanying drawings required to be used in the embodiment will be briefly described below, and it is obvious that for those of ordinary skill in the art, other accompanying drawings can be obtained from these accompanying drawings without exerting creative work.

FIG. 1 is a schematic diagram of the workflow of a method for artificial intelligence recognition of ground penetrating radar images according to an embodiment of the present application;

FIG. 2 is an image recognition framework based on multi-layer feature fusion in a method for artificial intelligence recognition of ground penetrating radar images according to an embodiment of the present application;

FIG. 3 is an RPN network structure based on multi-layer feature integration in a method for artificial intelligence recognition of ground penetrating radar images according to an embodiment of the present application;

FIG. 4 is an image recognition network structure based on manual features and fused multi-layer features in a method for artificial intelligence recognition of ground penetrating radar images according to an embodiment of the present application;

FIG. 5 is a schematic diagram of the workflow of an image recognition method based on committee discrimination in a method for artificial intelligence recognition of ground penetrating radar images according to an embodiment of the present application; and

FIG. 6 is a schematic diagram of the structure of an apparatus for artificial intelligence recognition of ground penetrating radar images according to an embodiment of the present application.

### DESCRIPTION OF THE EMBODIMENTS

In the following two embodiments, the present application discloses a method and apparatus for artificial intelligence recognition of ground penetrating radar images to solve the technical problems that the existing automated recognition methods based on convolutional neural networks have the disadvantages that it is difficult to use a single feature to characterize the diseases with universality and versatility as the morphological characteristics of internal diseases of the same pavement structure vary.

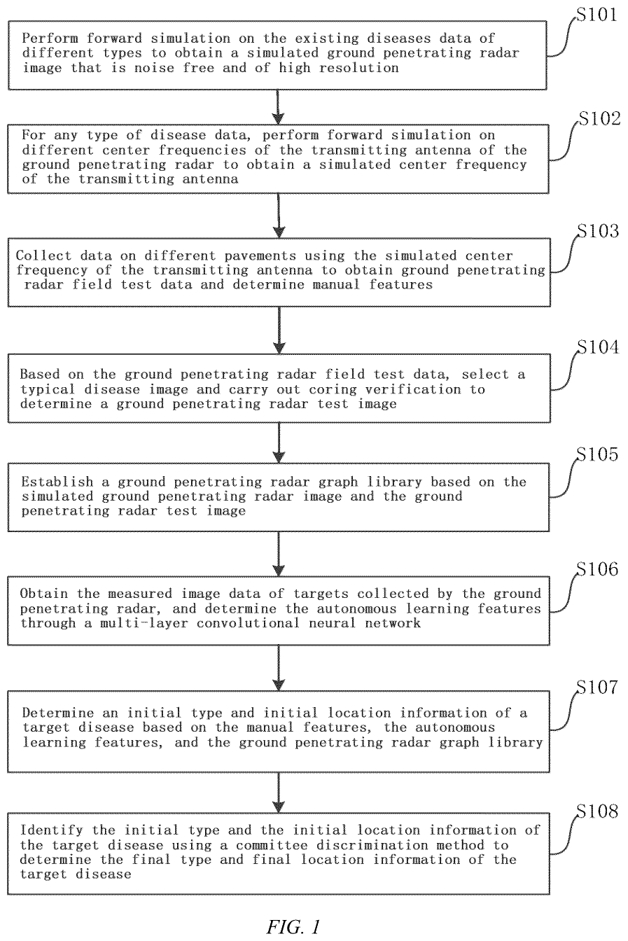

The first embodiment of the present application discloses a method for artificial intelligence recognition of ground penetrating radar images, as shown in the schematic workflow diagram of FIG. 1. The method comprises the following steps:

At S101, it performs forward simulation on the existing diseases data of different types to obtain a simulated ground penetrating radar image that is noise free and of high resolution.

In some embodiments of the present application, performing forward simulation on the existing diseases data of different types to obtain a simulated ground penetrating radar image comprises:
performing forward simulation on the existing diseases data of different types using GPRMAX based on finite-difference time-domain (FDTD) method to obtain the simulated ground penetrating radar image.

Further, the types of disease data include multiple gaps inside the pavement structure, poor interlayers, loose interlayers and loose structures.

Specifically, it uses GPRMAX based on finite-difference time-domain (FDTD) method to perform forward simulation on the diseases data, such as multiple gaps inside the pavement structure, poor interlayers, loose interlayers and loose structures, to obtain noise-free high-resolution ground penetrating radar images, and analyzes the response characteristics and laws of the electromagnetic waves in the diseases, such as phase, two-way travel time, and amplitude. The forward simulation comprises the following steps of building a disease model based on the actual application scenario, set the parameters of the disease model, performing the forward simulation on the computer, performing data analysis and parameter adjustment, and finally outputting noise-free high-resolution ground penetrating radar images.

At S102, for any type of disease data, it performs forward simulation on different center frequencies of the transmitting antenna of the ground penetrating radar to obtain a simulated center frequency of the transmitting antenna.

Specifically, the influence of the center frequency of the transmitting antenna on the ground penetrating radar image is studied to provide a theoretical basis for ground penetrating radar image recognition.

At S103, it collects data on different pavements using the simulated center frequency of the transmitting antenna to obtain ground penetrating radar field test data and determine manual features.

At S104, based on the ground penetrating radar field test data, it selects a typical disease image and carries out coring verification to determine a ground penetrating radar test image.

Specifically, the field test data of ground penetrating radar is studied, and the influencing factors in the actual detection process of ground penetrating radar images are analyzed. The simulated center frequency of the transmitting antenna obtained by forward modeling in S102 is used to collect data of different pavements. The ground penetrating radar images of the diseases of various pavements are analyzed. Typical disease images are selected for coring to verify the accuracy of the ground penetrating radar images.

At S105, it establishes a ground penetrating radar graph library based on the simulated ground penetrating radar image and the ground penetrating radar test image.

In some embodiments of the present application, establishing a ground penetrating radar graph library based on the simulated ground penetrating radar image and the ground penetrating radar test image comprises:
reconstructing and expanding the simulated ground penetrating radar image and the ground penetrating radar test image using data augmentation technology and transfer learning technology to establish the ground penetrating radar graph library.

Further, the ground penetrating radar graph library includes images of non-diseases, images of multiple gaps, images of poor interlayers, images of loose interlayers and images of loose structures.

Specifically, the ground penetrating radar test images obtained through forward simulation and verified through actual measurement are processed by data augmentation technology and transfer learning technology to obtain a data set with sufficient samples, which are reconstructed into unified, high-resolution ground penetrating radar images. A ground penetrating radar graph library including five types of images, including images of non-diseases, images of multiple gaps, images of poor interlayers, images of loose interlayers and images of loose structures, is established, and the target image labels of different disease types are orthogonally encoded to provide a basis for the subsequent automatic recognition of ground penetrating radar images.

Given the diverse morphology, variable features, difficulty in obtaining training samples, and insufficient sample size of ground penetrating radar images of internal diseases in pavement structures, this embodiment performs forward simulation of ground penetrating radar and constructs a ground penetrating radar graph library. The electromagnetic wave response characteristics of different types of diseases inside the pavement structure are the foundation of ground penetrating radar detection technology, and the establishment of a ground penetrating radar graph library is the foundation of automatic recognition of ground penetrating radar images in this embodiment. The present invention obtains noise-free high-resolution simulated ground penetrating radar images through forward simulation, and then performs reconstruction and expansion using the high-resolution simulated ground penetrating radar images and the ground penetrating radar test images that have been verified through actual measurement to obtain a unified and high-resolution ground penetrating radar graph library. Further, the resolution of ground penetrating radar images obtained by different center frequencies of the ground penetrating radar transmitting antenna is analyzed, which provides a theoretical basis for establishing stable automatic recognition of ground penetrating radar images.

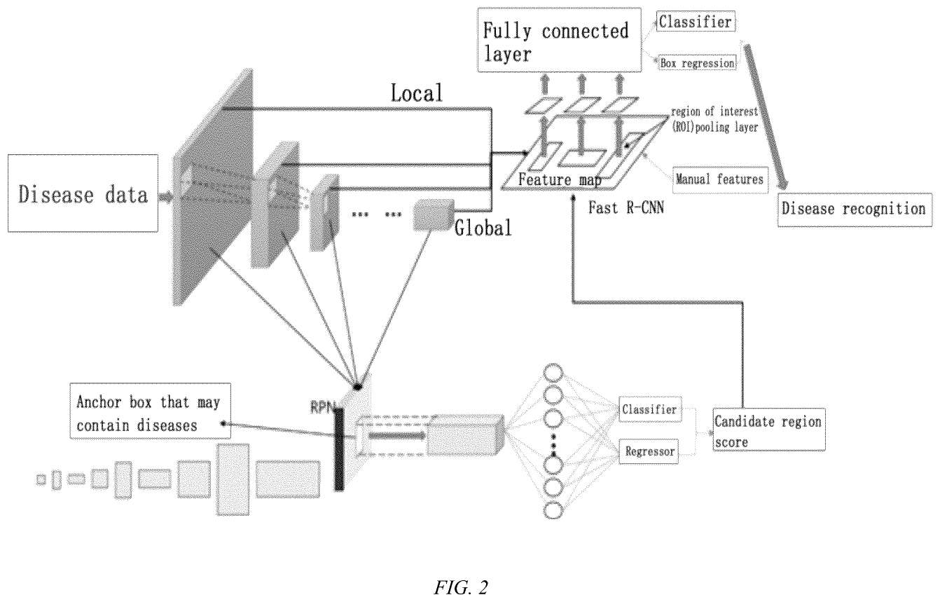

Given the diverse and variable feature forms of ground penetrating radar images of internal diseases of the pavement structure, and even the small scale of some diseases, this embodiment has designed an image recognition framework based on multi-layer feature fusion, as shown in FIG. 2, comprising the autonomous learning features extracted by the multi-layer convolutional neural network and the manual features determined in S103. The image recognition framework based on multi-layer feature fusion mainly includes two parts: an RPN structure based on multi-layer feature fusion; and an image recognition network structure based on manual features and fused multi-layer features.

At S106, it obtains the measured image data of targets collected by the ground penetrating radar, and determines the autonomous learning features through a multi-layer convolutional neural network.

In some embodiments of the present application, obtaining the measured image data of targets collected by the ground penetrating radar, and determining the autonomous learning features through a multi-layer convolutional neural network comprises:
determining a feature layer and generating a candidate region box by subjecting the measured image data of the target to a pre-constructed region proposal network (RPN) structure based on multi-layer feature fusion in the multi-layer convolutional neural network; and
performing a non-negative maximum suppression operation on the candidate region box and summarizing it to determine the autonomous learning feature.

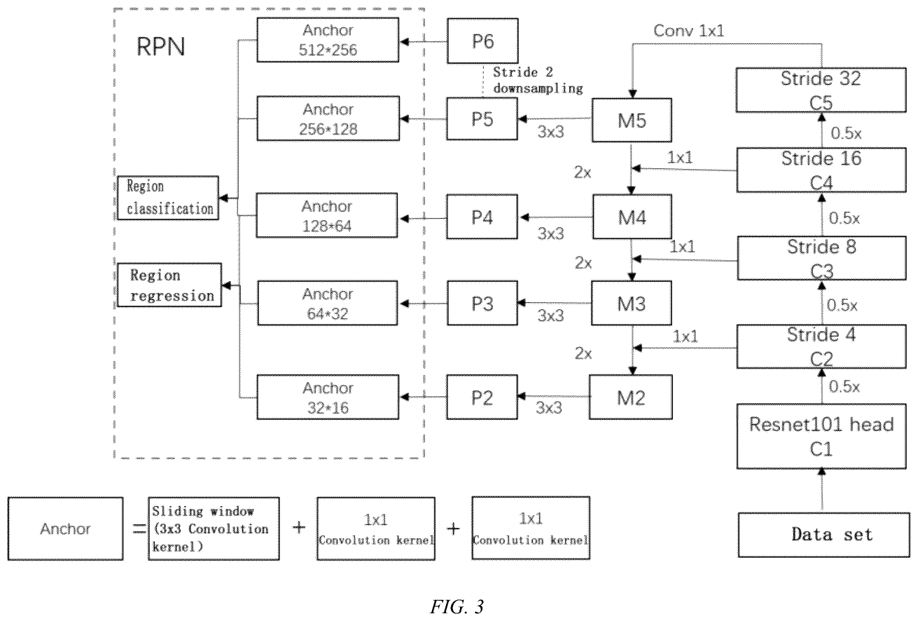

Specifically, the RPN structure based on multi-layer feature fusion is shown in FIG. 3. According to the measured image data of the target collected by the ground penetrating radar, the new feature layers P2-P6 are generated as follows. A feature layer C5 is convolved using a 1*1 convolution kernel to obtain a feature layer M5, and then M5 is convolved using 3*3 convolution to obtain a feature layer P5. The function of 1*1 convolution is to reduce the number of channels so that it can match the previous feature layer, and the function of 3*3 convolution is to eliminate the aliasing effect between different layers. A feature layer C4 is convolved using a 1*1 convolution kernel and the feature layer M5 is doubled by using the nearest neighbor upsampling method. The convolved C4 and the doubled M5 are added and fused to obtain a feature layer M4, which is then subjected to 3*3 convolution to obtain a feature layer P4. A feature layer C3 is convolved using a 1*1 convolution kernel and the feature layer M4 is doubled by using the nearest neighbor upsampling method. The convolved C3 and the doubled M4 are added and fused to obtain a feature layer M3, which is then subjected to 3*3 convolution to obtain a feature layer P3. A feature layer C2 is convolved using a 1*1 convolution kernel and the feature layer M3 is doubled by using the nearest neighbor upsampling method. The convolved C2 and the doubled M3 are added and fused to obtain a feature layer M2, which is then subjected to 3*3 convolution to obtain a feature layer P2. The maximum pooling operation is performed on the feature layer P5 to obtain a feature layer P6, where the convolution kernel size is 3*3 and the step size is 2.

As described above, new feature layers P2-P6 are obtained after feature fusion, and anchor boxes are generated on these feature layers through the RPN network. These anchor boxes are subjected to region classification and region regression. The original image recognition network uses three sizes {1282, 2562, 5122} and three aspect ratios {0.5, 1, 2} in the layer C5 to generate a total of nine sizes of anchor boxes. The image recognition network based on multi-layer feature fusion generates five sizes {32*16, 64*32, 128*64, 256*128, 512*256} of anchor boxes in the layers P2, P3, P4, P5 and P6 respectively, with the anchor boxes of each layer corresponding to three aspect ratios {0.5, 1, 2}. Therefore, the RPN based on multi-layer feature fusion corresponds to one size of anchor box in each feature layer, generating a total of 15 different sizes of anchor boxes.

The region classification prediction and region regression prediction of the RPN network based on multi-layer feature fusion are consistent with the traditional image recognition algorithm. In the RPN training phase, there are five feature layers input to the RPN, so the total loss is the sum of the classification loss and the regression loss. In the RPN prediction phase, the candidate region boxes generated by the feature layers P2-P6 are subjected to non-maximum suppression (NMS) operations respectively, and then the candidate boxes after NMS are summarized to obtain regions of interest (RoIs), that is, the autonomous learning features.

At S107, it determines an initial type and initial location information of a target disease based on the manual features, the autonomous learning features, and the ground penetrating radar graph library; and

In some embodiments of the present application, determining an initial type and initial location information of a target disease based on the manual features, the autonomous learning features, and the ground penetrating radar graph library comprises:
determining the initial type and initial location information of the target disease by subjecting the manual features and the autonomous learning features to a pre-constructed image classification network structure based on manual features and fused multi-layer features, and based on the ground penetrating radar graph library.

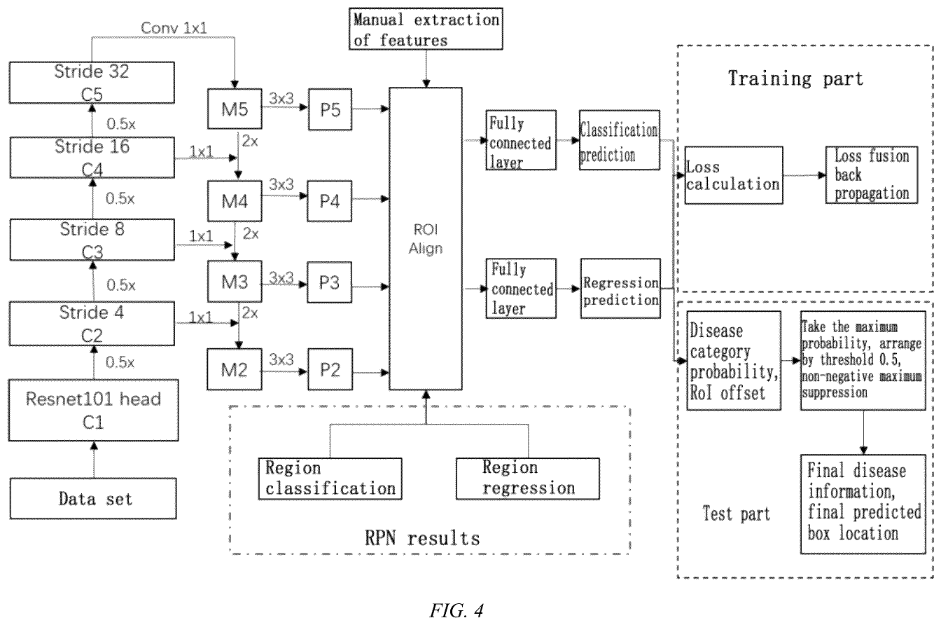

Specifically, the image recognition network structure based on manual features and fused multi-layer features is shown in FIG. 4. The RoIs generated by the NMS operation are subjected to final classification and box correction through the generated feature layers. The original image recognition network structure directly maps all RoIs to the last feature layer for feature extraction. However, the fused multi-layer feature layers are P2-P5, therefore a feature layer needs to be selected for each RoI for mapping. To this end, the multi-layer features provide a discrimination strategy for RoI mapping, mapping the RoIs of different sizes to the most appropriate feature layer. The specific mapping details are shown in the following formula:

$$k = [ {k}_{0} + {log}_{2} ( \sqrt{wh} / 200 ) ] ;$$

where k represents the mapping of RoI to the layer Pₖ, k=2,3,4,5 w and h represent the width and height of the input image, k₀ is the reference value set to 5 and represents the output of the layer P5. For example, assuming that the size of an RoI is 512×256 the above formula gives k=[k₀+0.69]=[5+0.69]=5 and the RoI is mapped to the feature layer P5. In order to prevent the result from not being an integer, the value k is rounded down, and the obtained RoI can correspond to the feature layers P2-P5.

After adding manually extracted features to the feature layers P2-P5, the RoI alignment method is used to cancel the integer operation and the obtained pixel values with floating point coordinates are subjected to bilinear interpolation, thereby transforming the entire feature aggregation process into a continuous operation. After RoI alignment, two fully connected layers are connected for classification prediction and regression prediction, respectively. During training, the loss adjustment parameters are calculated by back propagation. During recognition, the initial type and initial location information of the target disease are obtained by taking the maximum probability, sorting according to the threshold and using non-negative maximum suppression.

The internal diseases of the pavement structure have various morphologies, variable features, and small scales, making them difficult to identify. By analyzing the forward simulation, measured data and coring verification of different diseases, this embodiment summarizes the manual features of the radar image, and designs a reasonable RPN structure based on multi-layer feature fusion by combining the manual features with the autonomous learning features extracted by the multi-layer convolutional neural network. The candidate region boxes generated by the feature layers are subjected to the non-negative maximum suppression (NMS) operation, and then the candidate boxes after NMS are summarized to obtain the RoIs. On this basis, an image recognition network structure based on manual features and fused multi-layer features is designed to achieve classification prediction and regression prediction of internal diseases of pavement structure and obtain the initial type and initial location information of target diseases.

At S108, it identifies the initial type and the initial location information of the target disease using a committee discrimination method to determine the final type and final location information of the target disease.

In some embodiments of the present application, identifying the initial type and the initial location information of the target disease using a committee discrimination method to determine the final type and final location information of the target disease comprises:
establishing a committee comprising a plurality of discrimination methods; and
for any discrimination method, identifying the initial type and the initial location information of the target disease; and
judging whether the recognition results of the plurality of discrimination methods are consistent, if so, the final type and the final location information of the target disease are determined based on the recognition result; if not, the committee votes to determine the final type and the final location information of the target disease.

Further, the plurality of discrimination methods includes Softmax discrimination method, Triplet discrimination method and K-L discrimination method.

The classification accuracy of the image classification methods is not only affected by features, but also by discrimination methods. Therefore, the research on feature extraction methods and discrimination methods is of equal importance. This embodiment analyzes different discrimination methods, including Softmax discrimination method, Triplet discrimination method and K-L discrimination method, and organizes different discrimination methods into committees to study the multi-committee discrimination mechanism. On the basis of the research on the multi-committee discrimination method of ground penetrating radar images, an image classification method based on committee discrimination is formed to realize the automatic recognition of ground penetrating radar images of internal diseases of pavement structures.

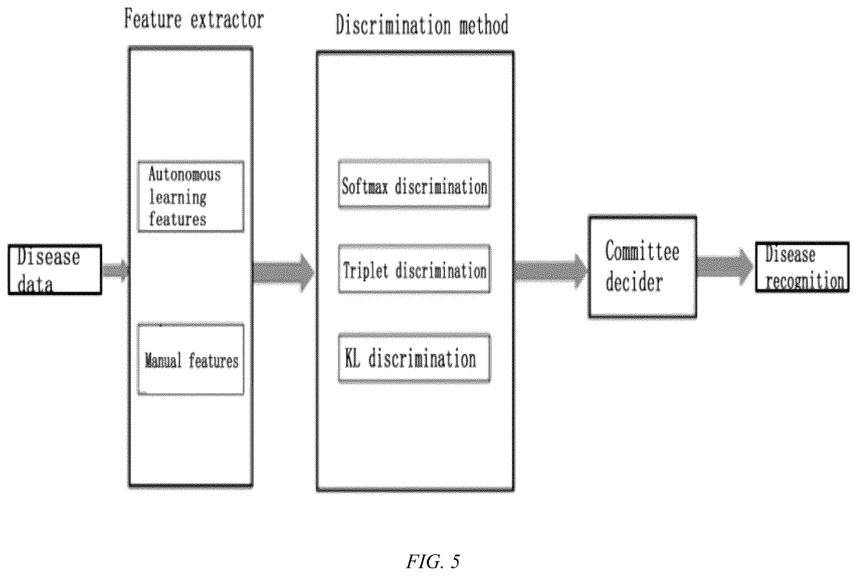

One of the main advantages of deep learning is that the feature extraction network and the discrimination methods are directly connected, and the parameters of the feature extraction method and the discrimination methods are modified simultaneously through learning to achieve “end-to-end” learning. The above mainly describes the feature extraction achieved by designing a suitable convolutional neural network structure, and this embodiment mainly involves the discrimination methods. In this embodiment, three discrimination methods are mainly considered, including the Softmax discrimination method, the Triplet discrimination method and the K-L discrimination method. These three methods use different metrics to achieve image classification, so the features extracted during training have certain differences, resulting in differences in the final classification results. To improve the classification accuracy of radar images, a committee is established as shown in FIG. 5, consisting of members including Softmax discrimination method, Triplet discrimination method, and K-L discrimination method.

When the autonomous learning features and manual features are input into each discrimination method, each discrimination method provides its own classification result. The classification result of the respective discrimination methods may be consistent or inconsistent. For the case of consistency, the result is the final classification result. When the classification results of the respective discrimination methods are inconsistent, the committee votes and gives the final recognition results, whereby the final type and the final location information of the target disease are obtained.

The method for artificial intelligence recognition of ground penetrating radar images disclosed in the above embodiment of the present application first obtains a noise-free high-resolution simulated ground penetrating radar image through forward simulation. Then, it obtains the ground penetrating radar field test data and determines the manual features. It establishes a ground penetrating radar graph library based on the simulated ground penetrating radar image and the ground penetrating radar test image. It uses a multi-layer convolutional neural network to process the measured image data of the target to determine the autonomous learning features. Finally, it determines the final type and final location information of the target disease based on the manual features, the autonomous learning features, and the ground penetrating radar graph library using the committee discrimination method. The present application can effectively improve the accuracy and efficiency of recognition of internal diseases in pavement structures by constructing a ground penetrating radar graph library that integrates manual features and autonomous learning features, in combination with the committee discrimination method.

The following is an embodiment of the apparatus of the present application, which can be used to implement the embodiment of the method of the present application. For details not disclosed in the embodiment of the apparatus of the present application, please see the embodiment of the method of the present application.

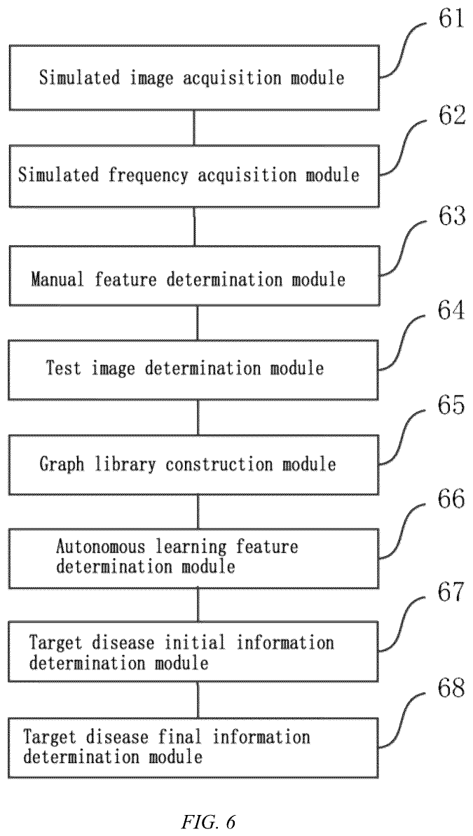

The second embodiment of the present application discloses an apparatus for artificial intelligence recognition of ground penetrating radar images for use in method for artificial intelligence recognition of ground penetrating radar images described according to the first embodiment of the present application, as shown in FIG. 6, comprising:
a simulated image acquisition module 61 configured to perform forward simulation on the existing diseases data of different types to obtain a simulated ground penetrating radar image that is noise free and of high resolution;
a simulated frequency acquisition module 62 configured to, for any type of disease data, perform forward simulation on different center frequencies of the transmitting antenna of the ground penetrating radar to obtain a simulated center frequency of the transmitting antenna;
a manual feature determination module 63 configured to collect data on different pavements using the simulated center frequency of the transmitting antenna to obtain ground penetrating radar field test data and determine manual features;
a test image determination module 64 configured to, based on the ground penetrating radar field test data, select a typical disease image and carry out coring verification to determine a ground penetrating radar test image;
a graph library construction module 65 configured to establish a ground penetrating radar graph library based on the simulated ground penetrating radar image and the ground penetrating radar test image;
an autonomous learning feature determination module 66 configured to obtain the measured image data of targets collected by the ground penetrating radar 66, and determine the autonomous learning features through a multi-layer convolutional neural network;
a target disease initial information determination module 67 configured to determine an initial type and initial location information of a target disease based on the manual features, the autonomous learning features, and the ground penetrating radar graph library; and
a target disease final information determination module 68 configured to identify the initial type and the initial location information of the target disease using a committee discrimination method to determine the final type and final location information of the target disease.

Further, the simulated image acquisition module 61 comprises:
a GPRMAX unit configured to perform forward simulation on the existing diseases data of different types using GPRMAX based on finite-difference time-domain (FDTD) method to obtain the simulated ground penetrating radar image.

Further, the graph library construction module 65 comprises:
a reconstruction and expansion unit configured to reconstruct and expand the simulated ground penetrating radar image and the ground penetrating radar test image using data augmentation technology and transfer learning technology to establish the ground penetrating radar graph library.

Further, the autonomous learning feature determination module 66 comprises:
a candidate region box generation unit configured to determine a feature layer and generate a candidate region box by subjecting the measured image data of the target to a pre-constructed RPN network structure based on multi-layer feature fusion in the multi-layer convolutional neural network; and
an autonomous learning feature acquisition unit configured to perform a non-negative maximum suppression operation on the candidate region box and summarize it to determine the autonomous learning feature.

Further, the target disease initial information determination module 67 comprises:
a target disease initial information acquisition unit configured to determine the initial type and initial location information of the target disease by subjecting the manual features and the autonomous learning features to a pre-constructed image classification network structure based on manual features and fused multi-layer features, and based on the ground penetrating radar graph library.

Further, the target disease final information determination module 68 comprises:
a committee establishment unit configured to establish a committee comprising a plurality of judgment methods;
a recognition result determination unit configured to, for any discrimination method, identify the initial type and the initial location information of the target disease and determine the recognition result; and
a target disease final information acquisition unit configured to judge whether the recognition results of the plurality of discrimination methods are consistent, if so, the final type and the final location information of the target disease are determined based on the recognition result; if not, the committee votes to determine the final type and the final location information of the target disease.

The present application is described in detail above in combination with specific implementations and exemplary embodiments, but these descriptions cannot be understood as limiting the present application. Those skilled in the art understand that, without departing from the spirit and scope of the present application, various equivalent substitutions, modifications or improvements can be made to the technical solution and embodiments of the present application, all of which fall within the scope of the present application. The scope of protection of the present application shall be subject to the attached claims.

1. A method for artificial intelligence recognition of ground penetrating radar images, comprising:
performing forward simulation on the existing diseases data of different types to obtain a simulated ground penetrating radar image that is noise free and of high resolution;
for any type of disease data, performing forward simulation on different center frequencies of the transmitting antenna of the ground penetrating radar to obtain a simulated center frequency of the transmitting antenna;
collecting data on different pavements using the simulated center frequency of the transmitting antenna to obtain ground penetrating radar field test data and determine manual features;
based on the ground penetrating radar field test data, selecting a typical disease image and carrying out coring verification to determine a ground penetrating radar test image;
establishing a ground penetrating radar graph library based on the simulated ground penetrating radar image and the ground penetrating radar test image;
obtaining the measured image data of targets collected by the ground penetrating radar, and determining the autonomous learning features through a multi-layer convolutional neural network;
determining an initial type and initial location information of a target disease based on the manual features, the autonomous learning features, and the ground penetrating radar graph library; and
identifying the initial type and the initial location information of the target disease using a committee discrimination method to determine the final type and final location information of the target disease.

2. The method for artificial intelligence recognition of ground penetrating radar images according to claim 1, wherein performing forward simulation on the existing diseases data of different types to obtain a simulated ground penetrating radar image comprises:
performing forward simulation on the existing diseases data of different types using GPRMAX based on finite-difference time-domain (FDTD) method to obtain the simulated ground penetrating radar image.

3. The method for artificial intelligence recognition of ground penetrating radar images according to claim 1, wherein the types of disease data include multiple gaps inside the pavement structure, poor interlayers, loose interlayers and loose structures.

4. The method for artificial intelligence recognition of ground penetrating radar images according to claim 1, wherein establishing a ground penetrating radar graph library based on the simulated ground penetrating radar image and the ground penetrating radar test image comprises:
reconstructing and expanding the simulated ground penetrating radar image and the ground penetrating radar test image using data augmentation technology and transfer learning technology to establish the ground penetrating radar graph library.

5. The method for artificial intelligence recognition of ground penetrating radar images according to claim 1, wherein the ground penetrating radar graph library includes images of non-diseases, images of multiple gaps, images of poor interlayers, images of loose interlayers and images of loose structures.

6. The method for artificial intelligence recognition of ground penetrating radar images according to claim 1, wherein obtaining the measured image data of targets collected by the ground penetrating radar, and determining the autonomous learning features through a multi-layer convolutional neural network comprises:
determining a feature layer and generating a candidate region box by subjecting the measured image data of the target to a pre-constructed region proposal network (RPN) structure based on multi-layer feature fusion in the multi-layer convolutional neural network; and
performing a non-negative maximum suppression operation on the candidate region box and summarizing it to determine the autonomous learning feature.

7. The method for artificial intelligence recognition of ground penetrating radar images according to claim 1, wherein determining an initial type and initial location information of a target disease based on the manual features, the autonomous learning features, and the ground penetrating radar graph library comprises:
determining the initial type and initial location information of the target disease by subjecting the manual features and the autonomous learning features to a pre-constructed image classification network structure based on manual features and fused multi-layer features, and based on the ground penetrating radar graph library.

8. The method for artificial intelligence recognition of ground penetrating radar images according to claim 1, wherein identifying the initial type and the initial location information of the target disease using a committee discrimination method to determine the final type and final location information of the target disease comprises:
establishing a committee comprising a plurality of discrimination methods; and
for any discrimination method, identifying the initial type and the initial location information of the target disease to determine the recognition result; and
judging whether the recognition results of the plurality of discrimination methods are consistent, if so, the final type and the final location information of the target disease are determined based on the recognition result; if not, the committee votes to determine the final type and the final location information of the target disease.

9. The method for artificial intelligence recognition of ground penetrating radar images according to claim 8, wherein the plurality of discrimination methods includes Softmax discrimination method, Triplet discrimination method and K-L discrimination method.

10. An apparatus for artificial intelligence recognition of ground penetrating radar images for use in the method for artificial intelligence recognition of ground penetrating radar images according to claim 1, comprising:
a simulated image acquisition module configured to perform forward simulation on the existing diseases data of different types to obtain a simulated ground penetrating radar image that is noise free and of high resolution;
a simulated frequency acquisition module configured to, for any type of disease data, perform forward simulation on different center frequencies of the transmitting antenna of the ground penetrating radar to obtain a simulated center frequency of the transmitting antenna;
a manual feature determination module configured to collect data on different pavements using the simulated center frequency of the transmitting antenna to obtain ground penetrating radar field test data and determine manual features;
a test image determination module configured to, based on the ground penetrating radar field test data, select a typical disease image and carry out coring verification to determine a ground penetrating radar test image;
a graph library construction module configured to establish a ground penetrating radar graph library based on the simulated ground penetrating radar image and the ground penetrating radar test image;
an autonomous learning feature determination module configured to obtain the measured image data of targets collected by the ground penetrating radar, and determine the autonomous learning features through a multi-layer convolutional neural network;
a target disease initial information determination module configured to determine an initial type and initial location information of a target disease based on the manual features, the autonomous learning features, and the ground penetrating radar graph library; and
a target disease final information determination module configured to identify the initial type and the initial location information of the target disease using a committee discrimination method to determine the final type and final location information of the target disease.
